(19) United States
(12) Patent Application Publication
(10) Pub. No.: US 2025/0309478 A1
(43) Pub. Date: Oct. 2, 2025

(54) SOLID-STATE SECONDARY BATTERY AND METHOD OF MANUFACTURING COATING SOLUTION FOR FORMING INTERMEDIATE LAYER OF SOLID-STATE SECONDARY BATTERY

(71) Applicant: HONDA MOTOR CO., LTD., Tokyo (JP)

(72) Inventor: Fumiyuki KOBAYASHI, Tokyo (JP)

(21) Appl. No.: 19/063,357

(22) Filed: Feb. 26, 2025

(30) Foreign Application Priority Data
Mar. 30, 2024 (JP) 2024-058353

(51) Int. Cl. H01M 50/483; H01M 50/474

(52) U.S. Cl. CPC H01M 50/483; H01M 50/474

(57) ABSTRACT

A solid-state secondary battery according to one embodiment of the present invention includes a positive electrode layer; a negative electrode layer; a solid-state electrolyte layer disposed between the positive electrode layer and the negative electrode layer; and an intermediate layer disposed between the negative electrode layer and the solid-state electrolyte layer. The intermediate layer contains carbon, silicon particles, and a binder. The intermediate layer has a composite modulus of elasticity of 200 MPa or less.

This application is based on and claims the benefit of priority from Japanese Patent Application No. 2024-058353, filed on 30 Mar. 2024, the content of which is incorporated herein by reference.

### BACKGROUND OF THE INVENTION

### Field of the Invention

The present invention relates to a solid-state secondary battery and a method of manufacturing a coating solution for forming an intermediate layer of the solid-state secondary battery.

### Related Art

In recent years, research and development has been conducted on secondary batteries that contribute to energy efficiency in order to ensure that more people have access to affordable, reliable, sustainable, and advanced energy. Among secondary batteries, solid-state secondary batteries including solid-state electrolytes have been attracting attention because of their superiority in terms of improved safety because the solid-state electrolyte is non-flammable, and higher energy density.

A solid-state secondary battery has a solid-state electrolyte layer between a positive electrode layer and a negative electrode layer. Solid-state lithium secondary batteries, in which the charge transfer medium is lithium ions, are known as solid-state batteries. Regarding the solid-state lithium secondary battery, a technique to place an intermediate layer containing carbon and metal nanoparticles between the negative electrode layer and the solid-state electrolyte layer to suppress non-uniform lithium deposition at the negative electrode layer interface has been studied (see Patent Document 1).
Patent Document 1: PCT International Publication No. WO2023/189892

### SUMMARY OF THE INVENTION

By the way, one of the challenges in technologies related to secondary batteries is to improve the output characteristics to enable discharge at high current density. An effective way to improve the output characteristics of solid-state secondary batteries is to place an intermediate layer with high conductivity of a charge transfer medium between the negative electrode layer and the solid-state electrolyte layer. In a solid-state lithium secondary battery that has been under study, however, the battery includes lithium or a lithium alloy as the material of the negative electrode active material layer of the negative electrode layer so that during charging, lithium ions are deposited on the surface of the negative electrode active material layer and form a lithium metal layer, and during discharge, lithium ions released from the lithium metal layer are absorbed into the positive electrode. In such a solid-state lithium secondary battery, changes in the thickness of the negative electrode layer due to charging and discharging can reduce adhesion between the negative electrode layer and the intermediate layer, resulting in a decrease in the output characteristics of the solid-state secondary battery.

An object of the present invention, which has been made in view of the above-mentioned problems, is to provide a solid-state secondary battery with improved output characteristics, and a coating solution for forming an intermediate layer, the coating solution enabling improvement in the output characteristics of the solid-state secondary battery. This ultimately contributes to energy efficiency.

In order to solve the above-mentioned problem, the inventors have found that it is effective to use, as an intermediate layer, a layer of a composition containing carbon, silicon particles, and a binder with a composite modulus of elasticity of 200 MPa or less. Thus, the present invention provides the following aspects.

A first aspect of the present invention relates to a solid-state secondary battery including a positive electrode layer; a negative electrode layer; a solid-state electrolyte layer disposed between the positive electrode layer and the negative electrode layer; and an intermediate layer disposed between the negative electrode layer and the solid-state electrolyte layer, in which the intermediate layer contains carbon, silicon particles, and a binder, and the intermediate layer has a composite modulus of elasticity of 200 MPa or less.

According to the solid-state secondary battery of the first aspect, the intermediate layer contains carbon, silicon particles, and a binder, which increases the conductivity of the charge transfer medium between the solid-state electrolyte and the negative electrode. Further, the composite modulus of elasticity of the intermediate layer is as low as 200 MPa or less, and its shape is easily deformable. Consequently, even if the negative electrode active material layer contains lithium or a lithium alloy and the thickness of the negative electrode layer changes due to charging and discharging, the negative electrode layer and the intermediate layer stay stable with high adhesion therebetween. This results in improvement in the output characteristics of the solid-state secondary battery.

A second aspect of the present invention relates to the solid-state secondary battery according to the first aspect, in which on the basis of a total amount of the carbon, the silicon particles, and the binder, a content of the carbon is in a range of 50 mass % or more and 90 mass % or less, a content of the silicon particles is in a range of 7 mass % or more and 45 mass % or less, and a content of the binder is in a range of 3 mass % or more and 8 mass % or less.

According to the solid-state secondary battery of the second aspect, the content of carbon, silicon particles, and binder in the intermediate layer is within the above-mentioned range, which increases the conductivity of the charge transfer medium in the intermediate layer and lowers the composite modulus of elasticity.

A third aspect of the present invention relates to the solid-state secondary battery according to the second aspect, in which the content of the binder is in a range of 3 mass % or more and 4 mass % or less.

According to the solid-state secondary battery of the third aspect, the binder content is within the above-mentioned range, which further increases the conductivity of the charge transfer medium in the intermediate layer.

A fourth aspect of the present invention relates to the solid-state secondary battery according to the second or third aspect, in which a ratio of the content of the silicon particles to the content of the carbon is in a range of 0.30 or more and 0.35 or less.

According to the solid-state secondary battery of the fourth aspect, a ratio of the silicon particle content to the carbon content is within the above-mentioned range, which further increases the conductivity of the charge transfer medium in the intermediate layer.

A fifth aspect of the present invention relates to the solid-state secondary battery according to any one of the first to fourth aspects, in which the carbon is carbon black that has a BET specific surface area in a range of 50 m²/g or more and 80 m²/g or less.

According to the solid-state secondary battery of the fifth aspect, binding carbon black with high specific surface area and silicon particles through a binder further increases the conductivity of the charge transfer medium in the intermediate layer and further lowers the composite modulus of elasticity.

A sixth aspect of the present invention relates to the solid-state secondary battery according to any one of the first to fifth aspects, in which the intermediate layer has a composite modulus of elasticity of 80 MPa or less.

According to the solid-state secondary battery of the sixth aspect, the composite modulus of elasticity is as low as 80 MPa or less and the shape is deformable, so that even if the negative electrode layer is deformed, the negative electrode layer and the intermediate layer stay stable with even higher adhesion therebetween.

A seventh aspect of the present invention relates to a method of manufacturing a coating solution for forming an intermediate layer of a solid-state secondary battery, including mixing a silicon particle dispersed solution, carbon, and a binder, the silicon particle dispersed solution being prepared by stirring silicon particles in a solvent at a stirring speed, represented by a peripheral speed, of greater than or equal to 20 m/sec and less than or equal to 40 m/sec for 60 seconds or more.

According to the method of manufacturing the coating solution for forming the intermediate layer of the solid-state secondary battery in the seventh aspect, a coating solution in which silicon particles are dispersed as primary particles or similar fine agglomerated particles can be prepared in an industrially advantageous manner. Use of this coating solution enables formation of an intermediate layer in which the conductivity of the charge transfer medium is high, the composite modulus of elasticity is low, and the shape is easily deformable.

The present invention makes it possible to provide a solid-state secondary battery with improved output characteristics, and a coating solution for forming an intermediate layer, the coating solution enabling improvement in the output characteristics of the solid-state secondary battery.

### BRIEF DESCRIPTION OF THE DRAWINGS

FIG. 1 is a schematic cross-sectional view of a solid-state secondary battery according to one embodiment of the present invention.

### DETAILED DESCRIPTION OF THE INVENTION

An embodiment of the present invention will be described below with reference to the accompanying drawing. However, the following embodiment merely illustrates the present invention and the present invention should not be limited to the following.

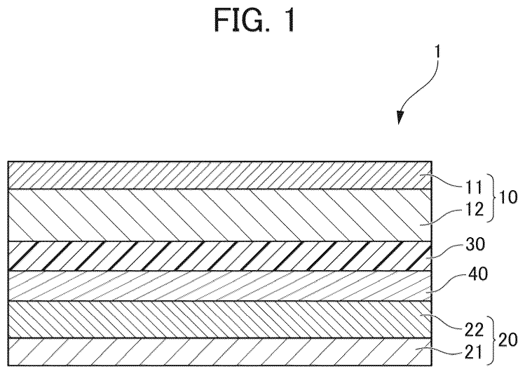

FIG. 1 is a schematic cross-sectional view of a solid-state secondary battery according to the embodiment of the present invention. As schematically shown in FIG. 1, the solid-state secondary battery 1 includes a positive electrode layer 10, a negative electrode layer 20, a solid-state electrolyte layer 30 disposed between the positive electrode layer 10 and the negative electrode layer 20, and an intermediate layer 40 disposed between the negative electrode layer 20 and the solid-state electrolyte layer 30.

The positive electrode layer 10 has a positive electrode current collector 11 and a positive electrode active material layer 12 stacked on the surface of the positive electrode current collector 11. Examples of materials for the positive electrode current collector 11 include aluminum, aluminum alloys, stainless steel, nickel, iron, and titanium.

The positive electrode active material layer 12 contains a positive electrode active material. The positive electrode active material is a lithium compound that releases lithium ions during discharge and absorbs lithium ions during charging. For example, layered active materials, spinel-type active materials, and olivine-type active materials can be used as lithium compounds. Specific examples of positive electrode active materials include lithium cobaltate (LiCoO₂), lithium nickelate (LiNiO₂), lithium nickel manganese cobalt oxide (NMC: LiNiₚMn_{q}COᵣO₂ (p+q+r=1), LiNiₚAl_{q}COᵣO₂ (p+q+r=1), lithium manganate (LiMn₂O₄), hetero-element substituted Li—Mn spinel represented by Li₁₊ₓMn_{2-x-y}MO₄ (x+y=2, M=at least one selected from Al, Mg, Co, Fe, Ni, and Zn), lithium titanate (oxide containing Li and Ti), and lithium metal phosphate (LiMPO₄, M=at least one selected from Fe, Mn, Co and Ni). The positive electrode active material layer 12 may further contain a solid-state electrolyte, a conductive aid, and a binder.

The negative electrode layer 20 includes a negative electrode current collector 21 and a negative electrode active material layer 22 stacked on the surface of the negative electrode current collector 21. Examples of materials for the negative electrode current collector 21 include copper, copper alloys, nickel, and stainless steel.

The negative electrode active material contained in the negative electrode active material layer 22 may be selected as appropriate from known materials that can absorb lithium ions during charging and release lithium ions during discharge. Examples of the negative electrode active material that can be used include metals, such as metallic lithium and lithium alloys, lithium transition metal oxides, such as lithium titanate, transition metal oxides, such as TiO₂, Nb₂O₃, and WO₃, Si, SiO, metal sulfides, metal nitrides, and carbon materials, such as artificial graphite, natural graphite, graphite, soft carbon, and hard carbon. Examples of metals contained in lithium alloys include Mg, Si, Au, Ag, In, Ge, Sn, Pb, Al and Zn. The negative electrode active material layer 22 may further contain a solid-state electrolyte, a conductive aid, and a binder.

The solid-state electrolyte layer 30 contains a solid-state electrolyte. Examples of solid-state electrolytes include sulfide solid-state electrolytes, oxide solid-state electrolytes, nitride solid-state electrolytes, and halide solid-state electrolytes. Examples of sulfide solid-state electrolytes include Li₂S—P₂S₅ and Li₂S—P₂S₅—LiI. The sulfide solid-state electrolyte may have an argyrodite crystal structure. Examples of oxide solid-state electrolytes include NASICON-type oxides, garnet-type oxides, and perovskite-type oxides. Examples of NASICON-type oxides include oxides containing Li, Al, Ti, P, and O (e.g., Li_{1.5}Al_{0.5}Ti_{1.5} (PO₄)₃). Examples of garnet-type oxides include oxides containing Li, La, Zr and O (e.g. Li₇La₃Zr₂O₁₂). Examples of perovskite-type oxides include oxides containing Li, La, Ti, and O (e.g. LiLaTiO₃).

The intermediate layer 40 contains carbon, silicon particles, and a binder. The intermediate layer 40 may be composed of only three components: carbon, silicon particles, and a binder. The content of carbon to the total amount of carbon, silicon particles, and binder may be, for example, in the range of 50 mass % or more and 90 mass % or less or 60 mass or more and 80 mass % or less. The silicon particle content may be, for example, in the range of 7 mass % or more and 45 mass % or less or 10 mass % or more and 40 mass % or less. The binder content may be in the range of 3 mass % or more and 8 mass % or less or 3 mass % or more and 4 mass % or less. The ratio of silicon particle content to carbon content (silicon particles/carbon) may be in the range of 0.30 or more and 0.35 or less.

The intermediate layer 40 has a composite modulus of elasticity of 200 MPa or less. The intermediate layer 40 has a low composite modulus of elasticity and is easily deformable. For example, if the thickness of the negative electrode layer 20 changes, the intermediate layer 40 deforms accordingly. This stabilizes the intermediate layer 40 and the negative electrode layer 20 with high adhesion therebetween. This allows the solid-state secondary battery 1 in this embodiment to have improved output characteristics. The composite modulus of elasticity of the intermediate layer 40 may be less than or equal to 150 MPa, less than or equal to 100 MPa, or less than or equal to 80 MPa. From the viewpoint of maintaining the shape of the intermediate layer 40, the composite modulus of elasticity of the intermediate layer 40 may be 10 MPa or higher.

The carbon in the intermediate layer 40 may be amorphous carbon. Examples of amorphous carbon include carbon blacks such as acetylene black, furnace black, and Ketjen black, coke, and activated carbon. Amorphous carbon may be graphitizable carbon (soft carbon), non-graphitizable carbon (hard carbon), CNTs (carbon nanotubes), fullerenes, or graphene.

The carbon in the intermediate layer 40 is preferably carbon black, and more preferably carbon black that has a BET specific surface area in the range of, for example, 50 m²/g or more and 80 m²/g or less. Binding carbon black that has high specific surface area and silicon particles through a binder yields an intermediate layer 40 that has high conductivity of lithium ions and low composite modulus of elasticity.

Examples of the binder contained in the intermediate layer 40 include:
acrylic acid-based polymers, cellulose-based polymers, styrene-based polymers, vinyl acetate-based polymers, urethane-based polymers, fluoroethylene-based polymers, and polyvinylidene fluoride (PVDF) polymers.

The intermediate layer 40 can be formed, for example, by a coating method. The coating method involves coating and drying a coating solution for forming the intermediate layer containing the material for the intermediate layer 40.

The method of manufacturing a coating solution for forming an intermediate layer may be, for example, a method in which a silicon particle dispersed solution prepared by stirring silicon particles in a solvent at a stirring speed, represented by a peripheral speed, of greater than or equal to 20 m/sec and less than or equal to 40 m/sec for 60 seconds or longer, carbon, and a binder are mixed. The silicon particle dispersed solution may contain silicon particles dispersed in the form of primary particles or fine agglomerated particles that are similar to primary particles. A high-speed stirrer can be used as a stirring device to disperse the silicon particles.

The solid-state secondary battery 1 is manufactured by stacking the positive electrode layer 10, the solid-state electrolyte layer 30, the intermediate layer 40, and the negative electrode layer 20 in the order shown in FIG. 1. Note that after stacking as described above, the stacked layers may be optionally pressed into one piece. Further, the configuration unit shown in FIG. 1 may be used as a unit battery and stacked in multiple layers.

In the solid-state secondary battery 1 of this embodiment configured in the above-mentioned manner, the intermediate layer 40 contains carbon, silicon particles, and a binder, which increases the conductivity of the charge transfer medium between the solid-state electrolyte and the negative electrode. The composite modulus of elasticity of the intermediate layer 40 is as low as 200 MPa or less, and its shape is easily deformable, so that the negative electrode layer 20 and the intermediate layer 40 stay stable with high adhesion therebetween even if the negative electrode active material layer 22 contains lithium or a lithium alloy and the thickness of the negative electrode layer 20 changes during charging and discharging. This contributes to an improvement in the output characteristics of the solid-state secondary battery 1.

According to this method of manufacturing a coating solution for forming an intermediate layer of a solid-state secondary battery of this embodiment, a coating solution in which silicon particles are dispersed as primary particles or similar fine agglomerated particles can be obtained in an industrially advantageous manner. Use of this coating solution enables formation of an intermediate layer 40 in which the conductivity of the charge transfer medium is high, the composite modulus of elasticity is low, and the shape is easily deformable.

### EXAMPLES

The present invention will be described in detail below through Examples. However, the present invention is not limited to these Examples.

### Example 1

### [Preparation of Coating Solution for Forming Intermediate Layer]

Five parts by mass of silicon particles were added to NMP (N-methyl-2-pyrrolidone), and the mixture was stirred using a high-speed stirrer (FILMIX manufactured by PRIMIX Corporation) at a stirring speed, represented as peripheral speed, of 30 m/sec and stirring time of 150 seconds, thereby preparing a silicon particle dispersed solution. Next, 71 parts by mass of carbon A (carbon black with a BET specific surface area of 62 m²/g) and 5 parts by mass of PVDF binder were added to the silicon particle dispersed solution, and the mixture was stirred and mixed using a high-speed stirrer (FILMIX manufactured by PRIMIX Corporation). Thus, the coating solution for forming the intermediate layer was prepared.

### [Preparation of Laminate of Intermediate Layer/Pellet-Shaped Solid-State Electrolyte Base/Intermediate Layer]

An argyrodite sulfide solid-state electrolyte was pressurized and molded to prepare a solid-state electrolyte base which has a pellet shape with flat top and bottom surfaces. The intermediate layer coating solution was applied to each of the top and bottom surfaces of the resulting solid-state electrolyte base, and dried to prepare a laminate of intermediate layer/pellet-shaped solid-state electrolyte base/intermediate layer.

### [Evaluation]

### (Measurement of Composite Modulus of Elasticity)

The composite modulus of elasticity was measured for one of the resulting intermediate layers. The results are shown in Table 1 below.

### (Measurement of Limiting Current Density)

A laminated electrode was prepared by laminating a metallic lithium foil on one surface of a copper foil. An evaluation cell of laminated electrode/intermediate layer/pellet-shaped solid-state electrolyte base/intermediate layer/laminated electrode was prepared by stacking the metal lithium foil of the laminated electrode on the respective surfaces of the intermediate layers of the laminate of intermediate layer/solid-state electrolyte layer/intermediate layer. The limiting current density of the resulting evaluation cell was measured. The results are shown in Table 1 below.

### Examples 2 to 4 and Comparative Example 1

Regarding the preparation of the coating solution for forming the intermediate layer, the coating solution for forming the intermediate layer was prepared in the same manner as in Example 1 except that the type of carbon, the amounts of carbon, silicon particles, and binder, and the conditions for dispersion of silicon particles were substituted for those listed in Table 1 below. Carbon A is carbon black with a BET specific surface area of 62 m²/g and Carbon B is carbon black with a BET specific surface area of 39 m²/g. Using the resulting coating solution for forming the intermediate layer, the laminate of intermediate layer/pellet-shaped solid-state electrolyte base/intermediate layer was prepared as in the same manner as in Example 1, and the composite modulus of elasticity and limiting current density were measured. The results are shown in Table 1 below.

TABLE 1

| | Preparation of coating solution for forming intermediate laye | | | | | | | | |
|---|---|---|---|---|---|---|---|---|---|
| | | | | | | Conditions for | | | |
| | | | | | | dispersion of | | Evaluation | |
| | | | | | Silicon | silicon particles | | Composite | Limiting |
| | | Amount (parts by mass) | | | particles/ | Stirring | Stirring | modulus of | current |
| | Carbon | | Silicon | | carbon | speed | time | elasticity | density |
| | type | Carbon | particles | Binder | ratio | (m/sec) | (sec) | (Mpa) | (mA/cm²) |
| Example 1 | Carbon A | 71 | 24 | 5 | 0.34 | 30 | 150 | 190 | 22.9 |
| Example 2 | Carbon B | 71 | 24 | 5 | 0.34 | 30 | 150 | 96 | 19.1 |
| Example 3 | Carbon A | 73 | 24 | 3 | 0.33 | 30 | 150 | 114 | 22.9 |
| Example 4 | Carbon B | 73 | 24 | 3 | 0.33 | 30 | 150 | 61 | 24.8 |
| Comparative | Carbon A | 71 | 24 | 5 | 0.34 | 30 | 30 | — | 11.5 |
| Example 1 | | | | | | | | | |

The results of Examples 1 to 4 shown in Table 1 demonstrate that it is possible to obtain an intermediate layer with a composite modulus of elasticity of 200 MPa or less by using a coating solution for forming an intermediate layer prepared by mixing a silicon particle dispersed solution in which silicon particles are dispersed with carbon, and a binder in accordance with the present invention. The evaluation cell including this intermediate layer exhibits a high limiting current density, showing that the solid-state secondary battery including this intermediate layer offers improved output characteristics. On the other hand, the evaluation cell including the intermediate layer of the silicon particle dispersed solution of Comparative Example 1, in which the dispersion time of the silicon particles was short, had a lower limiting current density.

### EXPLANATION OF REFERENCE NUMERALS

1 Solid-state secondary battery
10 Positive electrode layer
11 Positive electrode current collector
12 Positive electrode active material layer
20 Negative electrode layer
21 Negative electrode current collector
22 Negative electrode active material layer
30 Solid-state electrolyte layer
40 Intermediate layer

What is claimed is:

1. A solid-state secondary battery comprising:
a positive electrode layer;
a negative electrode layer;
a solid-state electrolyte layer disposed between the positive electrode layer and the negative electrode layer; and
an intermediate layer disposed between the negative electrode layer and the solid-state electrolyte layer, wherein
the intermediate layer contains carbon, silicon particles, and a binder, and
the intermediate layer has a composite modulus of elasticity of 200 MPa or less.

2. The solid-state secondary battery according to claim 1, wherein
on the basis of a total amount of the carbon, the silicon particles, and the binder, a content of the carbon is in a range of 50 mass % or more and 90 mass % or less, a content of the silicon particles is in a range of 7 mass % or more and 45 mass % or less, and a content of the binder is in a range of 3 mass or more and 8 mass % or less.

3. The solid-state secondary battery according to claim 2, wherein
the content of the binder is in a range of 3 mass or more and 4 mass % or less.

4. The solid-state secondary battery according to claim 2, wherein
a ratio of a content of the silicon particles to a content of the carbon is in a range of 0.30 or more and 0.35 or less.

5. The solid-state secondary battery according to claim 1, wherein
the carbon is carbon black that has a BET specific surface area in a range of 50 m²/g or more and 80 m²/g or less.

6. The solid-state secondary battery according to claim 1, wherein
the intermediate layer has a composite modulus of elasticity of 80 MPa or less.

7. A method of manufacturing a coating solution for forming an intermediate layer of a solid-state secondary battery, comprising:
mixing a silicon particle dispersed solution, carbon, and a binder, the silicon particle dispersed solution being prepared by stirring silicon particles in a solvent at a stirring speed, represented by a peripheral speed, of greater than or equal to 20 m/sec and less than or equal to 40 m/sec for 60 seconds or more.
